(19) United States
(12) Patent Application Publication
(10) Pub. No.: US 2024/0275466 A1
(43) Pub. Date: Aug. 15, 2024

(54) JOINT BEAM MANAGEMENT IN INTEGRATED TERRESTRIAL/NON-TERRESTRIAL NETWORKS

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 18/625,542

(22) Filed: Apr. 3, 2024

Related U.S. Application Data
(63) Continuation of application No. PCT/CN2021/123599, filed on Oct. 13, 2021.

(51) Int. Cl. H04B 7/06; H04L 5/00; H04W 24/08; H04W 84/06

(52) U.S. Cl. CPC H04B 7/0696; H04B 7/06964; H04L 5/0051; H04W 24/08; H04W 84/06

(57) ABSTRACT

According to embodiments, an apparatus receives beam failure detection reference signals on a plurality of beam pair links. The apparatus detects beam failure on at least some of the plurality of beam pair links. Responsive to a quantity of beam pair links on which the beam failure has been detected exceeding a predetermined quantity of beam pair links and being less than a total quantity of the plurality of beam pair links, the apparatus establishes a new beam pair link on a candidate beam.

### CROSS-REFERENCE TO RELATED APPLICATIONS

This application is a continuation of International Application No. PCT/CN2021/123599, filed on Oct. 13, 2021, which is hereby incorporated by reference in its entirety.

### TECHNICAL FIELD

The present disclosure relates, generally, to beam management for wireless communication and, in particular embodiments, to joint beam management in integrated terrestrial/non-terrestrial networks.

### BACKGROUND

As discussed herein, a reference to terrestrial radio access networks is a reference to the familiar cellular telephone and data networks. In contrast, a reference to non-terrestrial radio access networks is a reference to networks, or segments of networks, using an airborne vehicle or a spaceborne vehicle for signal transmission and reception.

Examples of spaceborne vehicles used for non-terrestrial radio access networks include: Low Earth Orbiting (LEO) satellites; Medium Earth Orbiting (MEO) satellites; Geostationary Earth Orbiting (GEO) satellites; and Highly Elliptical Orbiting (HEO) satellites. Examples of airborne vehicles used for non-terrestrial radio access networks include High Altitude Platforms (HAPs) such as Unmanned Aircraft Systems (UAS) including Lighter than Air (LTA) UAS and Heavier than Air (HTA) UAS. These platforms typically operate at altitudes between 8 km and 50 km and are considered to be quasi-stationary.

Terrestrial networks (TNs) are known to employ airborne transmit and receive points (TRPs). Airborne TRPs are typically deployed at around 100 m aboard drone-type vehicles. Airborne TRPs may be considered part of a TN or non-terrestrial network (NTN) depending on whether the airborne TRP connects to a terrestrial core network using a wireless backhaul directly through the TN or indirectly through the NTN.

Developments in wireless, cellular communication have allowed for base stations to communicate with user equipment, and user equipment to communicate with base stations, using directional energy, generally referenced as “beams.” Accordingly, modern wireless devices are known to engage in beam management procedures.

Current beam management procedures in cellular systems include beam sweeping for initial access, physical layer beam measurements, beam failure detection and beam failure recovery. In particular, the physical layer beam measurements may measure a so-called layer 1 reference signal received power (L1-RSRP) or a so-called layer 1 signal-to-interference-and-noise ratio (L1-SINR). All these procedures are related to monitoring “mobility within a cell” and, thus, these procedures are not designed to extend beyond a coverage area corresponding to a particular cell served by a particular base station.

Beam Failure Detection (BFD) procedures in cellular systems may be based on monitoring, by user equipment (UE), various qualities of a link to the serving base station. The UE may detect and take measurements of BFD reference signals (BFD-RS). Based on those measurements, the UE may compare the Block Error Rate (BLER) of the BFD-RS to a hypothetical physical downlink control channel (PDCCH) BLER. If the BLER of the BFD-RS is below the hypothetical PDCCH BLER, then a beam failure instance (BFI) may be considered to have taken place. A “beam failure” may be considered to have been detected when several consecutive BFIs have occurred.

A beam failure recovery (BFR) procedure in cellular systems may be based on initiating, by the UE, a search for a new serving beam. The UE may initiate the search responsive to a beam failure having been detected on a current serving beam. The UE may be pre-configured with so-called “candidate beams”, wherein a candidate beam corresponds to a beam that the UE may use to establish a new beam pair link with the network, following beam failure detection. A beam typically refer to a spatial filter, wherein a spatial filter is a signal processing technique applied by devices such as UEs, TRPs for the purpose of directional communication. As part of the search, the UE may attempt to detect and measure candidate beams. The UE may determine which of the candidate beams is the “best” beam. If the quality of the best beam is above a certain threshold, the UE may then initiate a so-called Random Access procedure as a final step in the BFR procedure.

Current beam management procedures in 5G NR are known to include inherently time-consuming aspects. Even as beam management functions, such as BFD and BFR, are restricted to the serving cell, it can take a significant amount of time for a UE to find a usable candidate beam. This significant amount of time can result in data sessions getting dropped in time-sensitive scenarios.

### SUMMARY

Aspects of the present application relate to proactive beam management procedures defined in conjunction with scenario-driven beam failure instance weights.

Current beam management procedures in 5G NR are known to have a restricted scope, which limits their efficiency. Because beam management procedures are limited to the serving cell, candidate beams are also limited to the serving cell and, therefore, a UE has no opportunity to consider candidate beams associated with neighbor terrestrial TRPs or candidate beams associated with non-terrestrial TRPs. If no suitable candidate beam is found, the UE randomly selects a candidate beam from among the beams of the terrestrial serving cell.

Additionally, current beam management procedures in 5G NR are known to be reactive in nature. Throughout this application, a beam pair link is the wireless link between a transmitter and a receiver (for instance, a TRP and a UE), wherein the transmitter (e.g., the TRP) uses a transmit beam and the receiver (e.g., the UE) uses a receive beam for the purpose of communication. When a final operational serving beam pair link fails, it may be considered to be already too late for the UE to recover from the impact and, accordingly, the UE has to spend time finding a suitable candidate beam. Moreover, a TRP cannot assist the UE in the beam management process after all of the beam pair links have failed.

Conveniently, when a TRP and a UE carry out beam management procedures jointly, scenario-driven beam management is enabled. The TRP may exercise control over candidate beams being given higher importance in various scenarios.

Joint TRP/UE beam management also allows for integration between terrestrial wireless coverage and non-terrestrial wireless coverage. The TRP is provided with an ability to configure non-terrestrial beam pair links, allowing the UE to make use of terrestrial TRPs and non-terrestrial TRPs seamlessly. The TRP is provided with an ability to configure non-terrestrial beams as candidate beams, allowing the UE to establish non-terrestrial BPLs whenever appropriate.

Joint TRP/UE beam management also allows for interruption-free service, wherein the UE is allowed to maintain a functional beam pair link while proactively scanning for candidate beams. The scanning may be triggered, for example, when only one beam pair link remains functional.

According to an aspect of the present disclosure, there is provided a method of beam failure recovery. The method includes receiving first beam failure detection reference signals on a first beam pair link, receiving second beam failure detection reference signals on a second beam pair link, detecting, based on measuring the first beam failure detection reference signals, a first plurality of beam failure instances, detecting, based on measuring the second beam failure detection reference signals, a second plurality of beam failure instances, forming a weighted sum of beam failure instances, including the first plurality of beam failure instances weighted with a first weight and the second plurality of beam failure instances weighted with a second weight and, when the weighted sum exceeds a threshold, initiating a beam failure recovery procedure.

According to an aspect of the present disclosure, there is provided a device. The device includes a memory storing instructions, a receiver and a processor. The receiver is operable to receive first beam failure detection reference signals on a first beam pair link and receive second beam failure detection reference signals on a second beam pair link. The processor is caused, by executing the instructions, to detect, based on measuring the first beam failure detection reference signals, a first plurality of beam failure instances, detect, based on measuring the second beam failure detection reference signals, a second plurality of beam failure instances, form a weighted sum of beam failure instances, including the first plurality of beam failure instances weighted with a first weight and the second plurality of beam failure instances weighted with a second weight and initiate, when the weighted sum exceeds a threshold, a beam failure recovery procedure.

According to an aspect of the present disclosure, there is provided a method of beam failure prevention. The method includes receiving beam failure detection reference signals on a plurality of beam pair links, detecting, based on measuring the beam failure detection reference signals, a plurality of consecutive beam failure instances, detecting, based on the detecting the plurality of consecutive beam failure instances, beam failure on all beam pair links except one beam pair link among the plurality of beam pair links and, responsive to the detecting beam failure on all beam pair links except one beam pair link among the plurality of beam pair links, initiating a beam failure prevention procedure. The beam failure prevention procedure includes selecting a candidate beam among a plurality of candidate beams, thereby obtaining a selected candidate beam and establishing a new beam pair link on the selected candidate beam.

According to an aspect of the present disclosure, there is provided a device. The device includes a memory storing instructions, a receiver and a processor. The receiver is operable to receive beam failure detection reference signals on a plurality of beam pair links. The processor is caused, by executing the instructions, to detect, based on measuring the beam failure detection reference signals, a plurality of consecutive beam failure instances, detect, based on the detecting the plurality of consecutive beam failure instances, beam failure on all beam pair links except one beam pair link among the plurality of beam pair links and initiate, responsive to the detecting the beam failure on all beam pair links except one beam pair link among the plurality of beam pair links, a beam failure prevention procedure. The beam failure prevention procedure includes selecting a candidate beam among a plurality of candidate beams, thereby obtaining a selected candidate beam and establishing a new beam pair link on the selected candidate beam.

According to an aspect of the present disclosure, there is provided a method of beam failure prevention. The method includes receiving beam failure detection reference signals on a beam pair link, detecting a first type of beam failure on the beam pair link, the detecting the first type of beam failure based on measuring the beam failure detection reference signals and detecting a first plurality of consecutive beam failure instances, the first type of beam failure defined as a beam failure occurring while a beam failure prevention process is not active and, responsive to the detecting the beam failure on all beam pair links except one beam pair link among the plurality of beam pair links, initiating a beam failure prevention process. The beam failure prevention process includes scanning for candidate beams while continuing to receive beam failure detection reference signals on the beam pair link and selecting a candidate beam among a plurality of candidate beams, thereby obtaining a selected candidate beam and establishing a new beam pair link on the selected candidate beam.

According to an aspect of the present disclosure, there is provided a device. The device includes a memory storing instructions, a receiver and a processor. The receiver is operable to receive beam failure detection reference signals on a beam pair link. The processor is caused, by executing the instructions, to detect a first type of beam failure on the beam pair link based on measuring the beam failure detection reference signals and detecting a first plurality of consecutive beam failure instances, the first type of beam failure defined as a beam failure occurring while a beam failure prevention process is not active, and initiate, responsive to the detecting the first type of beam failure, a beam failure prevention process. The beam failure prevention process includes scanning for candidate beams while continuing to receive beam failure detection reference signals on the beam pair link, selecting a candidate beam among a plurality of candidate beams, thereby obtaining a selected candidate beam and establishing a new beam pair link on the selected candidate beam.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6A illustrates a representation of measurements performed on different beam pair links in a time division multiplexed manner, in accordance with aspects of the present application;

FIG. 6B illustrates a representation of measurements performed on different beam pair links in a simultaneous manner, in accordance with aspects of the present application;

FIG. 7 illustrates, in a signal flow diagram, interaction, for weighted beam failure instance derivation, between the example electronic device of FIG. 2, the example terrestrial transmit receive point of FIG. 2 and the example non-terrestrial transmit receive point of FIG. 2, in accordance with aspects of the present application;

FIG. 8 illustrates example steps in a method of weighted beam failure instance derivation and use, in accordance with aspects of the present application;

FIG. 9 illustrates, as a block diagram, a scenario wherein a user equipment is connected to a terrestrial transmit receive point using three beam pair links;

FIG. 10 illustrates, in a signal flow diagram, interaction, for beam failure prevention, between the example electronic device of FIG. 2, the example terrestrial transmit receive point of FIG. 2 and the example non-terrestrial transmit receive point of FIG. 2, in accordance with aspects of the present application;

FIG. 11 illustrates example steps in a method of beam failure prevention, in accordance with aspects of the present application;

FIG. 12 illustrates, in a signal flow diagram, interaction, for beam failure prevention, between the example electronic device of FIG. 2, the example terrestrial transmit receive point of FIG. 2 and the example non-terrestrial transmit receive point of FIG. 2, in accordance with aspects of the present application;

FIG. 13 illustrates example steps in a method of beam failure prevention, in accordance with aspects of the present application;

FIG. 14 illustrates, in a signal flow diagram, interaction, for beam failure recovery, between the example electronic device of FIG. 2, the example terrestrial transmit receive point of FIG. 2 and the example non-terrestrial transmit receive point of FIG. 2, in accordance with aspects of the present application; and

FIG. 15 illustrates example steps in a method of beam failure recovery with categorization, in accordance with aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

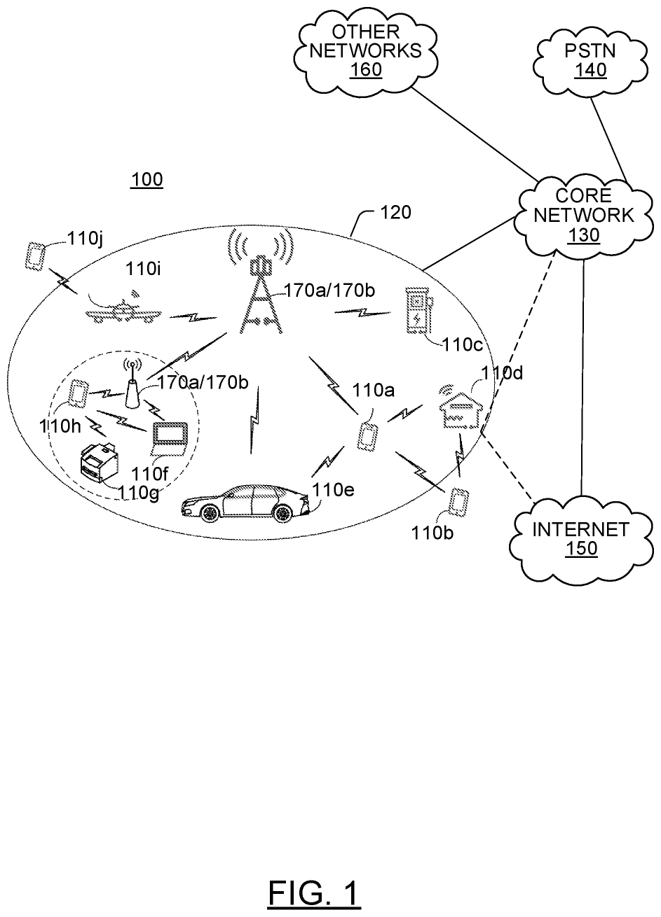

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

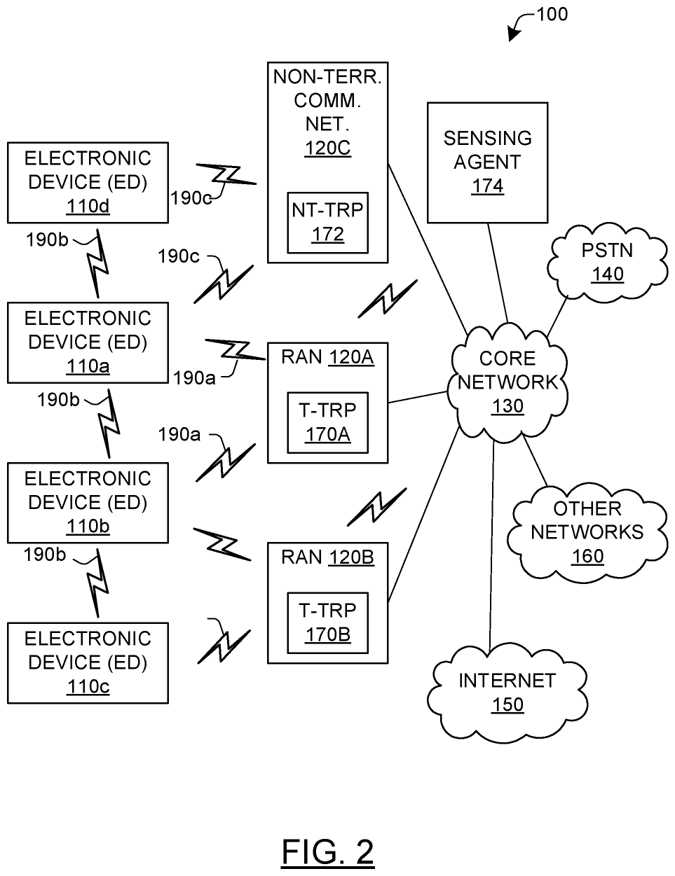

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over an non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

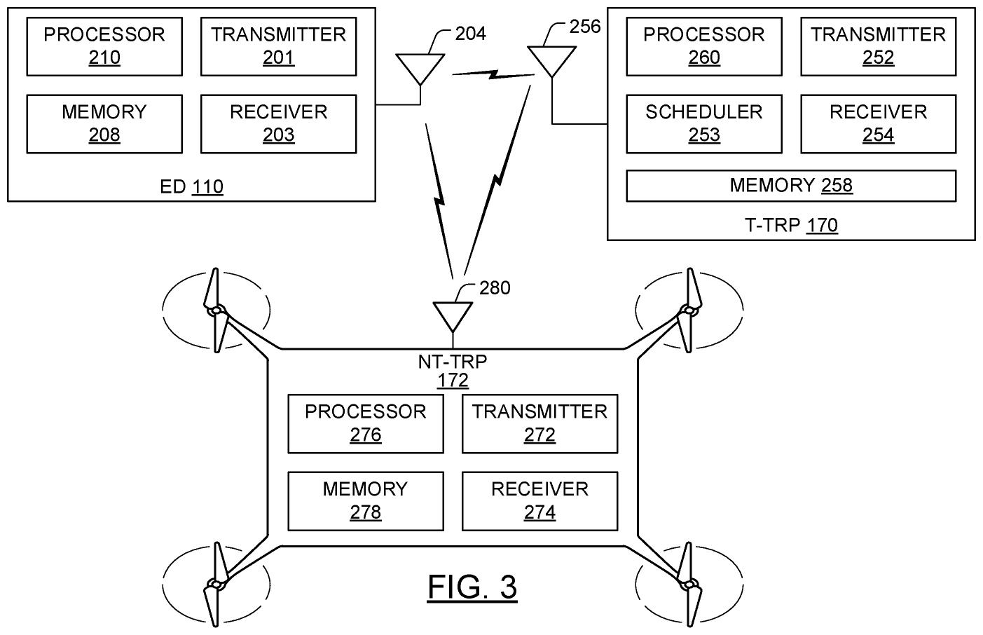

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

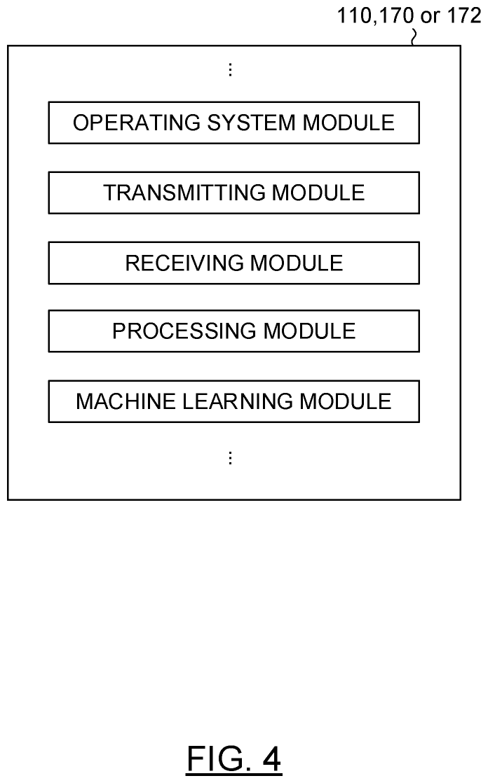

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs no in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0-5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

User Equipment (UE) position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information. UE pose information may be defined to include UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). Although the sensing system can be separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

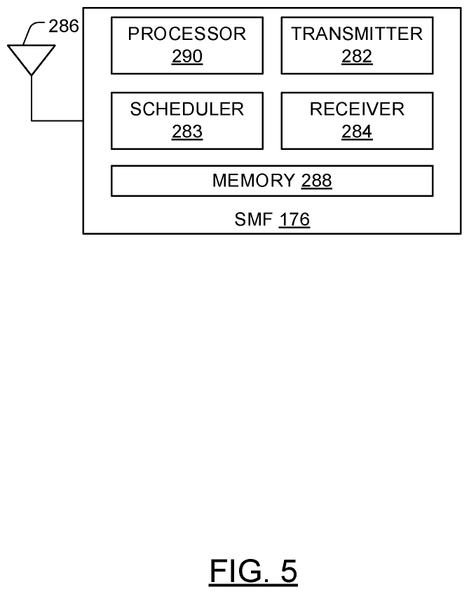

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, and a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability, because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node to have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as
B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the devices with limited power budget. The non-terrestrial communication system may be a communications system using Unmanned Aerial Vehicles (UAVs) (or unmanned aerial system, “UAS”) achieving a dense deployment, because their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each device to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and UEs and the effect of noise can be reduced.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

An antenna panel is a unit of an antenna group, or antenna array, or antenna sub-array. An antenna panel can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

In overview, aspects of the present application relate to pro-active beam management procedures defined in conjunction with scenario-driven beam failure instance (BFI) weights. In the context of this application, pro-active beam management procedures mean that the UE 110 takes steps and/or applies procedures to establish new beam pair links for the purpose of communications before all the UE's beam pair links fail. The steps and/or the procedures taken by the UE 110 may be scenario-driven, for instance the steps and procedures taken by the UE 110 when it is located in an urban area may differ from the steps and procedures taken by the UE 110 when it is located in a remote area.

Depending on a deployment scenario, a beam failure definition may be configured by the TRP 170/172 to guide behavior at the UE 110 regarding what constitutes a “beam failure.” In particular, a beam failure may be determined, by the UE 110, responsive to determining a weighted combination of BFIs taking place across terrestrial and non-terrestrial beam pair links (BPLs).

Instead of waiting for all BPLs to fail and, responsively, having the UE 110 initiate a beam failure recovery procedure, aspects of the present application relate to a beam failure prevention procedure. The beam failure prevention procedure may allow the UE 110 to start establishing new BPLs before all of the existing BPLs fail. The TRP 170/172 can also provide assistance, to the UE 110, by indicating directions of interest for the UE 110 to scan for candidate beams for establishing the new BPLs.

Depending on the TRP 170/172 deployment scenario and depending upon the initiating of a beam failure prevention, the UE 110 may scan for candidate beams to establish terrestrial or non-terrestrial BPLs. Different types of beam failure events may condition the behavior of the UE 110 when scanning for candidate beams from terrestrial/non-terrestrial TRPs.

According to aspects of the present application, a UE 110 is configured to take measurements during measurement intervals. In each measurement interval, the UE 110 may detect and measure reference signals corresponding to one BPL and can detect up to one BFI per measurement interval and per BPL.

To explain aspects of the present application, it may be assumed, to begin, that a UE 110 is connected to a network using a terrestrial sub-system among a plurality of sub-systems. Some sub-systems among the plurality of sub-systems are terrestrial and some sub-systems among the plurality of sub-systems are non-terrestrial. It is safe to assume that each sub-system is using different BPLs, where some of the BPLs correspond to terrestrial TRPs (such BPLs may be called “terrestrial BPLs”) and some of the BPLs correspond to non-terrestrial TRPs (such BPLs may be called “non-terrestrial BPLs”).

The TRP 170/172 may act to configure the UE 110 with the values Wₜₑᵣᵣ and Wₙₒₙ₋ₜₑᵣᵣ, where Wₜₑᵣᵣ is a weight given to BFIs detected on terrestrial BPLs and Wₙₒₙ₋ₜₑᵣᵣ is a weight given to BFIs detected on non-terrestrial BPLs. The values Wₜₑᵣᵣ and Wₙₒₙ₋ₜₑᵣᵣ can be positive integer values, positive decimal values, positive rational values or positive real values.

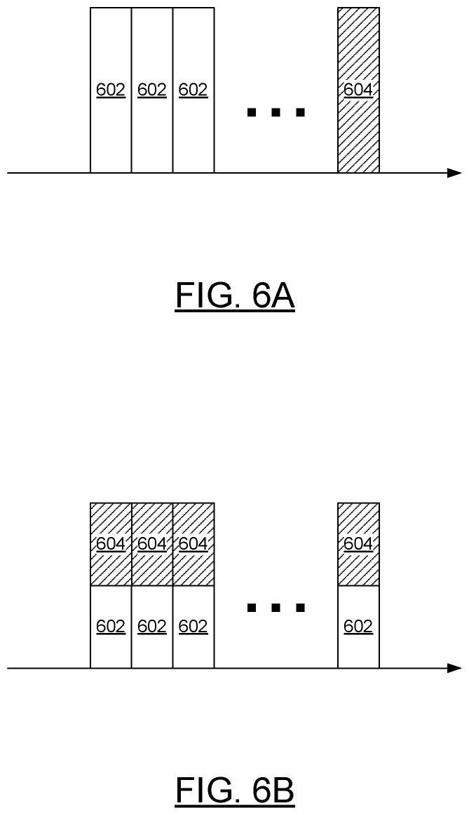

The UE 110 may monitor BFD-RSs received on different BPLs. The UE 110 may attempt to detect a BFD-RSs in a measurement interval associated with a particular BPL. Upon detecting a BFD-RS, the UE 110 may measure a quality of the BFD-RS. Measurement capability may differ among a plurality of UEs 110. With a time-division multiplexing (TDM) measurement capability, the UE 110 may perform measurements on different BPLs in a TDM-manner, as illustrated in FIG. 6A. With a simultaneous measurement capability, the UE 110 may perform measurements on different BPLs simultaneously, as illustrated in FIG. 6B. In FIGS. 6A and 6B, a first type of bar 602 is illustrated as representative of a BPL with a measured quality that exceeds a threshold. In FIG. 6A, a second type of bar 604 is illustrated as representative of a BPL with a measured quality that fails to exceed a threshold.

It may be considered that the UE 110 has detected a beam failure responsive to consecutive BFIs having been detected on one or more of the BPLs and the sum of the weights of individual BFIs being above a predetermined threshold.

In different scenarios, the weights attributed to terrestrial and non-terrestrial BFIs may be different. For example, in urban scenarios, the TRP 170/172 may establish a first configuration, wherein Wₜₑᵣᵣ>Wₙₒₙ₋ₜₑᵣᵣ. The first configuration may be viewed as suitable when beam failures on terrestrial BPLs are deemed more critical than beam failures on non-terrestrial BPLs. In other scenarios, such as remote/coastal scenarios, the TRP 170/172 may establish a second configuration, wherein Wₙₒₙ₋ₜₑᵣᵣ>Wₜₑᵣᵣ. The second configuration may be viewed as suitable when beam failures on non-terrestrial BPLs are deemed more critical than beam failures on terrestrial BPLs. Depending on which beams are deemed to be critical, the behavior of the UE 110 may involve scanning for candidate beams having a particular type, e.g., terrestrial or non-terrestrial.

In contrast to many known beam failure detection schemes, detected beam failure instances need not be consecutive in respect of a single beam pair link. For instance, we could have the following measurement configuration for beam failure instance detection:

BPL1: F-F-F-F-F-

BPL2: -F-F-F-F-F

From the perspective of BPL1 or the perspective of BPL2, the plurality of beam failure instances is not consecutive. However, viewed as a whole, the plurality of beam failure instances is consecutive.

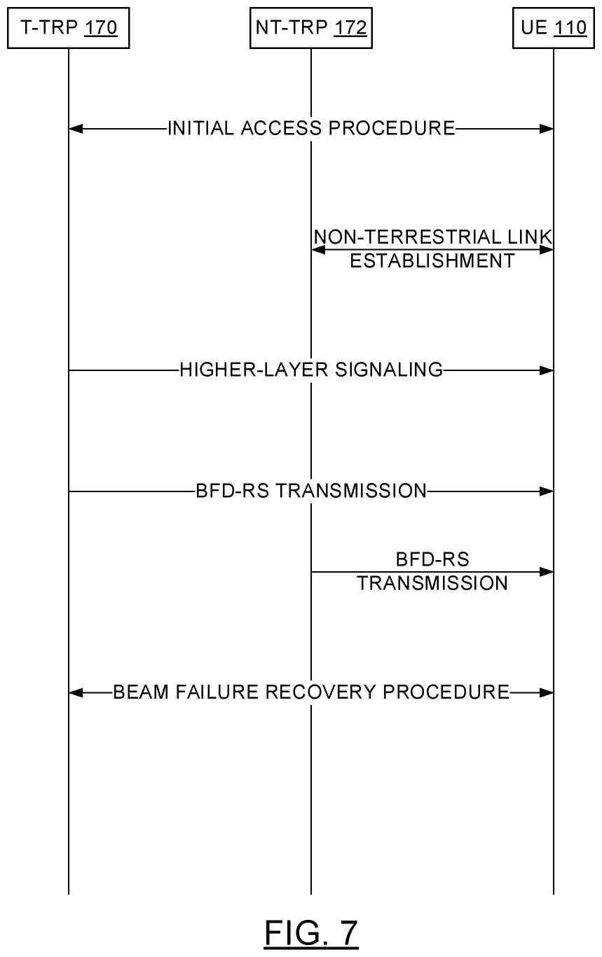

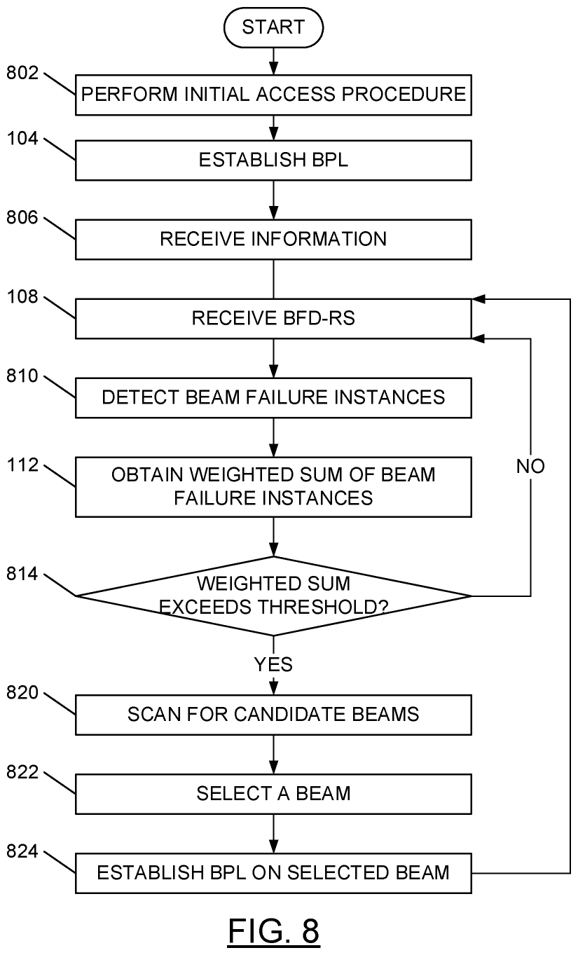

FIG. 7 illustrates, in a signal flow diagram, interaction between a UE 110, a T-TRP 170 and an NT-TRP 172. FIG. 8 illustrates example steps in a method of weighted BFI derivation and use.

To begin, the UE 110 performs (step 802) an initial access procedure, which results in the UE 110 synchronizing with and connecting with the T-TRP 170. As is typical, the UE 110 and the NT-TRP 170 negotiate (step 804) to establish a BPL. The T-TRP 170 transmits information to the UE 110 using higher-layer signaling. The UE 110 receives (step 806) the information. The information may, for example, include details of BFD-RSs to detect (such as the time and frequency resources occupied by the BFD-RSs, the initial value of the sequence, etc.) and, subsequently, measure. The information may, for example, also include directional details of candidate beams to which to switch in case of beam failure. The information may, for another example, include weights that may be applied to various types of BFIs. The T-TRP 170 and the NT-TRP 172 transmit respective BFD-RS. The UE 110 receives (step 808) the BFD-RSs from the T-TRP 170 and the NT-TRP 172. On the basis of receiving (step 808) and measuring the BFD-RSs (e.g., determining a BLER) received from the T-TRP 170 and the NT-TRP 172, the UE 110 may detect (step 810) a plurality of BFIs in a measurement window of a predetermined duration. The UE 110 may then obtain (step 812) a weighted sum of the BFIs detected in the measurement window.

It is notable that, in aspects of the present application, there is no requirement that BFIs be consecutive. However, it should be clear that a majority of situations of interest relate to detection of consecutive BFIs.

The UE 110 may then determine (step 814) whether the weighted sum of the BFIs exceeds a threshold.

As discussed hereinbefore, the weights assigned to the terrestrial BFIs may be different from the weights assigned to the non-terrestrial BFIs, dependent upon the scenario in which the UE 110 is operating.

In a first scenario, wherein terrestrial BFIs are given greater weight than non-terrestrial BFIs, based on determining (step 814) that the weighted sum of the BFIs exceeds a threshold, the UE 110 may initiate (step 816) a beam failure recovery procedure on the terrestrial link to the T-TRP 170. The beam failure recovery procedure may involve scanning (step 820) for terrestrial candidate beams. The scanning (step 820) for terrestrial candidate beams may involve detecting and measuring terrestrial candidate beams. The UE 110 may then select (step 822) a beam from the T-TRP 170 and establish (step 824) a BPL with the T-TRP 170 on the selected beam.

In a second scenario, wherein non-terrestrial BFIs are given greater weight than terrestrial BFIs, based on determining (step 814) that the weighted sum of the BFIs exceeds a threshold, the UE 110 may initiate (step 816) a beam failure recovery procedure on the non-terrestrial link to the NT-TRP 172. The beam failure recovery procedure may involve scanning (step 820) for non-terrestrial candidate beams. The scanning (step 820) for non-terrestrial candidate beams may involve detecting and measuring non-terrestrial candidate beams. The UE 110 may then select (step 822) a beam from the NT-TRP 172 and establish (step 824) a BPL with the NT-TRP 172 on the selected beam.

Upon determining (step 814) that the weighted sum of the beam failure instances does not exceed the threshold, the UE 110 may return to receiving (step 808) the BFD-RSs from the T-TRP 170 and the NT-TRP 172.

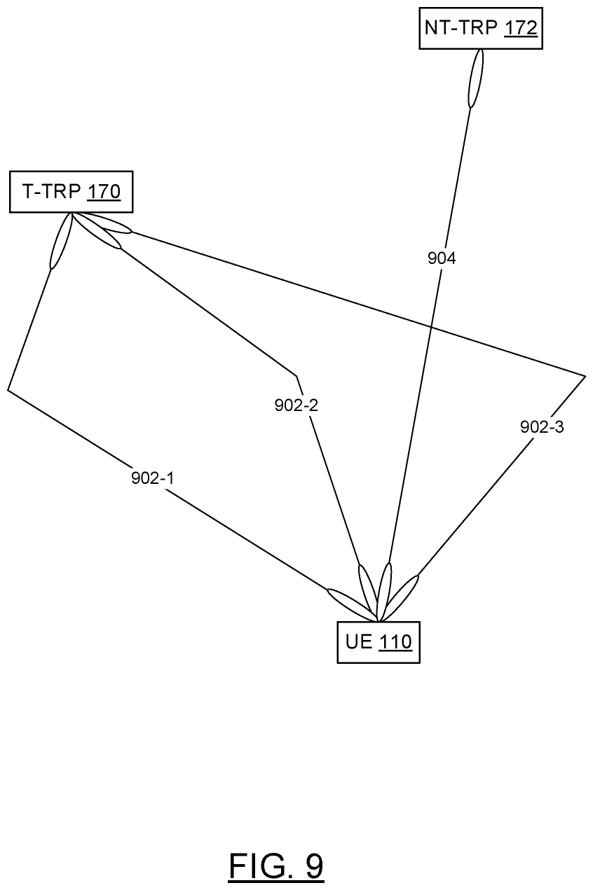

A scenario is illustrated in FIG. 9 wherein a UE 110 is connected to a T-TRP 170 using three BPLs: a first BPL 902-1; a second BPL 902-2; and a third BPL 902-3 (individually or collectively 902). Additionally, it is noted that the UE 110 uses a single antenna panel corresponding to each BPL 902.

In some embodiments, the weighted sum of the beam failure instances may be captured or expressed as a mathematical formula. The T-TRP 170 may use higher-layer signaling to configure the UE 110 with a measurement window whose size is specified in a given time-unit, e.g. OFDM symbol, group of OFDM symbols, mini-slot, slot, group of slots, subframe, group of subframes. Assuming that the UE 110 is configured with a measurement window of size N and the UE 110 has K beam pair links, the UE computes P as P=Σₖ₌₁^{K}wₖ (Σₙ₌₁^{N} BFI_{n,k}) using:
Wₖ as the weight of the k^{th} beam pair link; and
BFI_{n,k} as the beam failure instance detected in n-th time-unit of the k-th beam pair link.

In some embodiments, the weighted sum of the beam failure instances may be captured or expressed as a pseudo-code. The T-TRP 170 may use higher-layer signaling to configure the UE 110 with a measurement window whose size is specified in a given time-unit, e.g. OFDM symbol, group of OFDM symbols, mini-slot, slot, group of slots, subframe, group of subframes. Assuming that the UE 110 is configured with a measurement window of size N and the UE 110 has K beam pair links, the UE determines P according to the following pseudo-code:

```
set P = 0
set k = 1, where k is the index of the k^{th} beam pair link
  while k is lower than K
    if the k^{th} beam pair link is a terrestrial beam pair link
      set wₖ to Wₜₑᵣᵣ
    else
      set wₖ to Wₙₒₙ₋ₜₑᵣᵣ
    end if
    set n = 0, where n is the index of the n^{th} time unit in the measurement window
      while n is lower than N
        if a beam failure instance is detected
          increment P by wₖ
        end if
        increment n by 1
      end while
    increment k by 1
  end while
```

In some embodiments, the T-TRP 170 may configure the UE 110 with a measurement window for receiving and detecting BFD-RSs. The measurement window may, in some aspects, be defined by way of configuration parameters such as an absolute value for a starting point, an absolute value for an ending point and a periodicity. The measurement window may, in other aspects, be defined by way of configuration parameters such as an offset (for a starting point relative to the beginning of a radio frame), a duration and a periodicity. The configuration parameters may be expressed in terms of a corresponding time-unit, e.g., an OFDM symbol, a group of OFDM symbols, a mini-slot, a slot, a group of slots, a subframe, a group of subframes. As an example, a measurement window may be configured in slots, wherein the starting point and ending point are both given as a slot index and the starting point of the measurement window is configured such that the starting point matches with the beginning of a radio frame. The periodicity and the offset of the measurement window may be given in a number of slots with respect to a radio frame.

In some embodiments, the T-TRP 170 may configure the UE 110 with different thresholds for beam failure detection on different beam pair links. These thresholds may be defined for measurements of, e.g., RSRP, RSRQ, SINR or a hypothetical BLER.

The UE 110 may be in a situation wherein the UE 110 has detected a beam failure on the second BPL 902-2 and a beam failure on the third BPL 902-3, i.e., the second BPL 902-2 and the third BPL 902-3 have effectively failed and are no longer usable for communication. Each beam failure on the BPLs may be detected upon detection of a predetermined number of consecutive BFIs within a measurement window. In that situation, qualities (e.g., a BLER) of the BFD-RS on the first BPL 902-1 continue to be measured above a threshold used to detect beam failure. Furthermore, prior to when the second BPL 902-2 and the third BPL 902-3 have had their beam failures detected, the T-TRP 170 has provided, to the UE 110, candidate beam information.

Because the first BPL 902-1 is the only BPL 902 that remains functional, the UE 110 may be triggered, according to aspects of the present application, to initiate a beam failure prevention procedure. In the beam failure prevention procedure, the UE 110 may scan for candidate beams on which to establish a fallback BPL. Assuming that the candidate beam information, which was provided by the T-TRP 170, corresponds to an NT-TRP 172 (e.g., a drone), the UE 110 may establish a non-terrestrial BPL 904 as a fallback BPL.

Notably, the beam failure prevention procedure may be initiated after the detection of beam failure on the second BPL 902-2 and the third BPL 902-3. Such events can be detected using the weighted BFI mechanisms as described hereinbefore in conjunction with a review of FIG. 8.

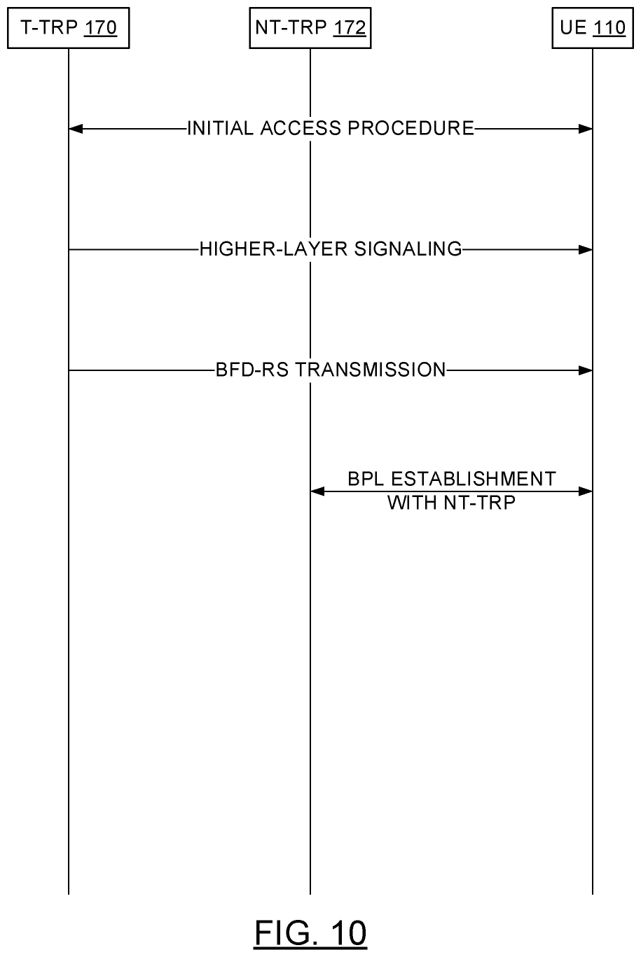

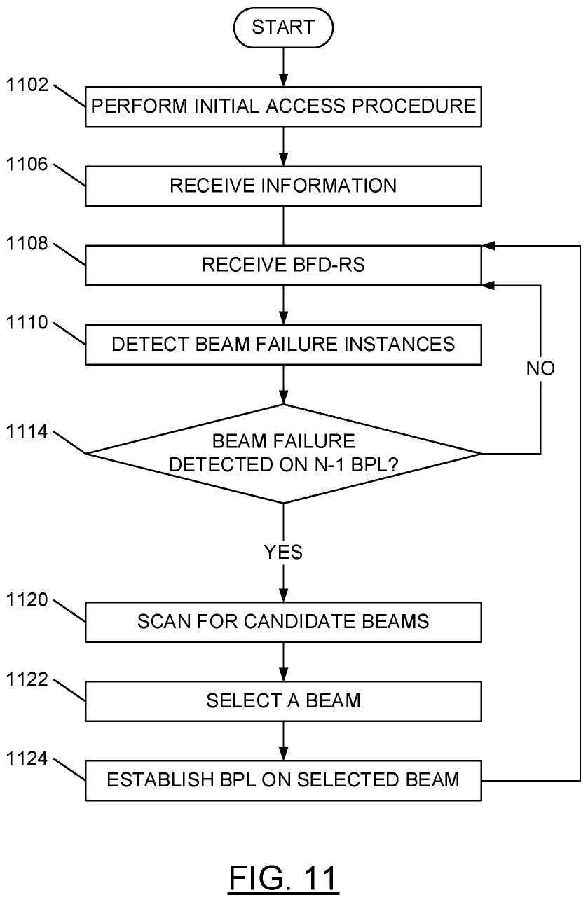

FIG. 10 illustrates, in a signal flow diagram, interaction between a UE 110, a T-TRP 170 and an NT-TRP 172. FIG. 11 illustrates example steps in a method of beam failure prevention.

To begin, the UE 110 performs (step 1102) an initial access procedure, which results in the UE 110 synchronizing with and connecting with the T-TRP 170. The T-TRP 170 transmits information to the UE 110 using higher-layer signaling. The UE 110 receives (step 1106) the information. The information may, for example, include details of BFD-RSs to detect (such as the time and frequency resources occupied by the BFD-RSs, the initial value of the sequence, etc.) and, subsequently, measure in the context of N BPLs. The information may, for example, also include directional information for candidate beams from the NT-TRPs 172. The T-TRP 170 transmits BFD-RS. The UE 110 receives (step 1108) the BFD-RSs from the T-TRP 170. On the basis of receiving (step 1108) and measuring the BFD-RSs from the T-TRP 170, the UE 110 may detect (step 1110) BFIs. Responsive to the detecting (step 1110), the UE 110 may determine (step 1114) whether beam failure has been detected for a predetermined number of BPLs. The predetermined number may be expressed in terms of the number, N, of BPLs. For example, the UE 110 may determine (step 1114) whether beam failure has been detected for all BPLs except one, in which case, the predetermined number is N−1. In the following, the predetermined number of BPLs, detection of which leads to initiation of a beam failure prevention procedure, is discussed as having particular value N−1. It should be clear that the predetermined number is configurable and need not always be N−1. Abeam failure may be detected for a particular BPL on the basis of a predetermined number of BFIs having been detected on the particular BPL during a predetermined time frame. In some aspects of the present application, the predetermined number of BFIs are consecutive.

Responsive to the determining (step 1114) that beam failure has been detected for N−1 BPLs, the UE 110 initiates a beam failure prevention procedure. The beam failure prevention procedure may involve the UE 110 scanning (step 1120) for candidate beams from the NT-TRPs 172. In particular, the UE 110 may scan in directions indicated in the information received in step 1106. The beam failure prevention procedure may also involve the UE 110 selecting (step 1122) a candidate beam from the NT-TRP 172 or another, more suitable NT-TRP (not illustrated). The beam failure prevention procedure may further involve the UE 110 establishing (step 1124) a fallback BPL with the NT-TRP 172 on the selected candidate beam.

Upon determining (step 1114) that beam failure has not been detected for N−1 BPLs, the UE 110 may return to receiving (step 1108) the BFD-RSs from the T-TRP 170.

In consideration of an alternate version of the scenario illustrated in FIG. 9, wherein a UE 110 is connected to a T-TRP 170 using three BPLs 902, the UE 110 may be in a situation wherein the UE 110 has detected a beam failure on the second BPL 902-2 and a beam failure on the third BPL 902-3, i.e., the second BPL 902-2 and the third BPL 902-3 have effectively failed and are no longer usable for communication. In that situation, qualities (e.g., BLER) of the BFD-RS on the first BPL 902-1 continue to be measured above a threshold used to detect a BFI.

Because the first BPL 902-1 is the only BPL 902 that remains functional, the UE 110 may be triggered, according to aspects of the present application, to initiate a beam failure prevention procedure. Unlike in the scenario discussed hereinbefore, it may be assumed, in this alternate scenario, that the T-TRP 170 has not provided, to the UE 110, any information about candidate beams. Instead, the T-TRP 170 may provide assistance to the UE 110 through a beam failure prevention mechanism that is based at the T-TRP 170.

After the UE 110 has detected that beam failures have occurred on the second BPL 902-2 and the third BPL 902-3, the UE 110 transmits, to the T-TRP 170, a UE report. The UE report may include an indication that beam failures have been detected for the second BPL 902-2 and the third BPL 902-3. The UE report may, in aspects of the present application, be transmitted over a PUCCH using the first BPL 902-1. The UE report may, in aspects of the present application, be transmitted in a PUCCH format message dedicated to the reporting on the state of the BPLs 902.

In some embodiments, the BPL failure report generated by the UE 110 includes: a BPL identifier of the BPL on which the beam failure instances were detected; a measurement report for the corresponding BPL including, e.g., an RSRP measurement, an RSRQ measurement and/or an SINR measurement; a number of beam failure instances that were detected on the corresponding BPL; a time-stamp of the first beam failure instance detected on the corresponding BPL; and a time-stamp of the last beam failure instance detected on the corresponding BPL.

In some embodiments, the UE 110 signals its capability of performing beam failure prevention procedures to the T-TRP 170, e.g., after completing the Initial Access procedure (step 1102). The capability of performing beam failure prevention may be mandatory or optional. As part of the capability of performing beam failure prevention, the UE 110 may also signal additional parameters such as:
the maximum number of BPLs that the UE 110 can maintain within a given time-unit, e.g., an OFDM symbol, a group of OFDM symbols, a slot, a mini-slot, a group of slots, a subframe, a group of subframes;
the maximum number of BFD reference signals that the UE 110 can be configured with overall for the purpose of running Beam Failure Prevention, which may further depend on the frequency range of the frequency band the UE 110 is operating in;
the maximum number of BFD reference signals per BPL that the UE 110 can be configured with for the purpose of running Beam Failure Prevention, which may further depend on the frequency range of the frequency band the UE 110 is operating in;
the maximum number of candidate beams that the UE 110 can be configured to monitor for the purpose of running Beam Failure Prevention, which may further depend on the frequency range of the frequency band the UE 110 is operating in, these candidate beams may alternatively be called Beam Failure Prevention reference signals (BFP-RS), Candidate Beam Detection reference signals (CBD-RS) or Fallback Beam reference signals (FB-RS);
the maximum number of terrestrial candidate beams that the UE 110 can be configured to monitor for the purpose of running Beam Failure Prevention, which may further depend on the frequency range of the frequency band the UE 110 is operating in; and
the maximum number of non-terrestrial candidate beams that the UE 110 can be configured to monitor for the purpose of running Beam Failure Prevention, which may further depend on the frequency range of the frequency band the UE 110 is operating in.

In some embodiments, the UE 110 generates an Uplink Control Information (UCI), wherein the UCI is defined as a string of bits containing uplink control information, such as HARQ acknowledgement bits or CSI report bits, to be transmitted by the UE 110 over a PUSCH transmission to the T-TRP 170, further containing BPL failure report bits. This UCI may be multiplexed with the UE's data packet (e.g., a Transport Block) carried by the PUSCH transmission to the T-TRP 170.

In some embodiments, the UE 110 applies some priority rules to determine whether to transmit the UCI containing the BPL failure report over a PUCCH transmission or over a PUSCH transmission. As an example, the UE 110 may apply a priority rule that makes the UE 110 send the BPL failure report over a PUSCH transmission if the total number of UCIs the UE 110 is sending over the PUCCH transmission is likely to exceed the PUCCH's capacity. As another example, the UE 110 may apply a priority rule that makes the UE 110 send the BPL failure report over a PUSCH transmission if the PUCCH transmission is likely to overlap on the time and frequency resources allocated to the PUSCH transmission.

In some embodiments, the UE 110 is expected to follow a default behavior when applying the Beam Failure Prevention procedure. As an example, one default UE behavior may be that the UE 110 doesn't multiplex other UCIs with the UCI carrying the BPL failure report. As another example, one default UE behavior may be that the UE 110 drops any PUSCH transmission if the PUCCH transmission carries a UCI containing the BPL failure report.

Following reception, by the T-TRP 170, of such a PUCCH transmission from the UE 110 over the first BPL 902-1, the T-TRP 170 may, responsively, transmit control signaling to the UE 110 over the first BPL 902-1. This control signaling may indicate candidate beams for the UE 110 to scan. The candidate beams may be defined in terms of directions of interest, using, e.g., Azimuth and Zenith angles defined in a given coordinate system, as determined by the T-TRP 170. The UE 110 may, in response to receiving the control signaling, scan for candidate beams in those directions of interest. The UE 110 may then establish a fallback BPL 904, e.g., with the NT-TRP 172.

Note that the beam failure prevention procedure is initiated, by the UE 110, after the beam failure has been detected for the second BPL 902-2 and the third BPL 902-3. Such beam failure may be detected on the basis of the weighted BFI mechanisms that are described hereinbefore.

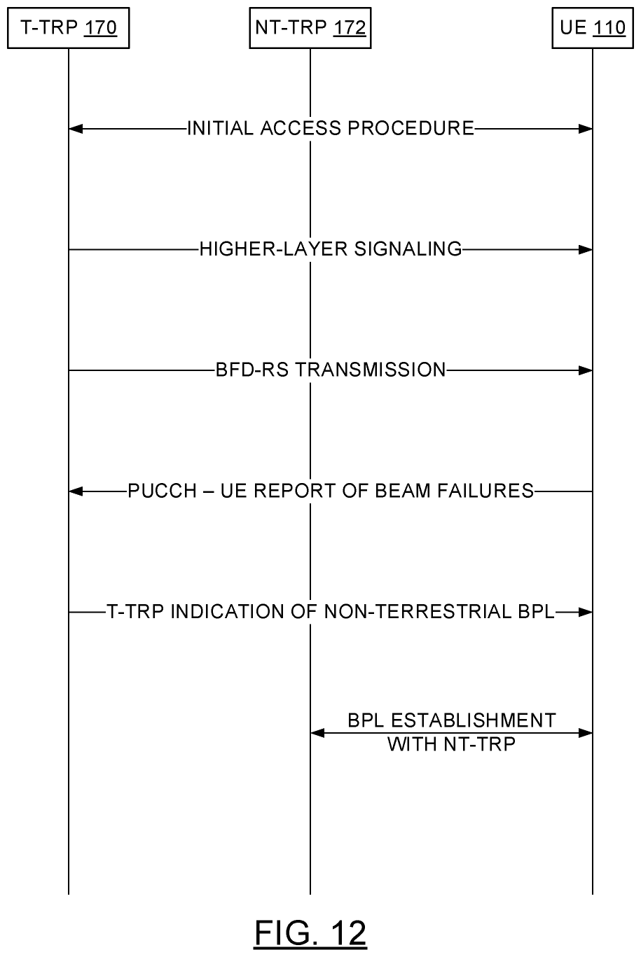

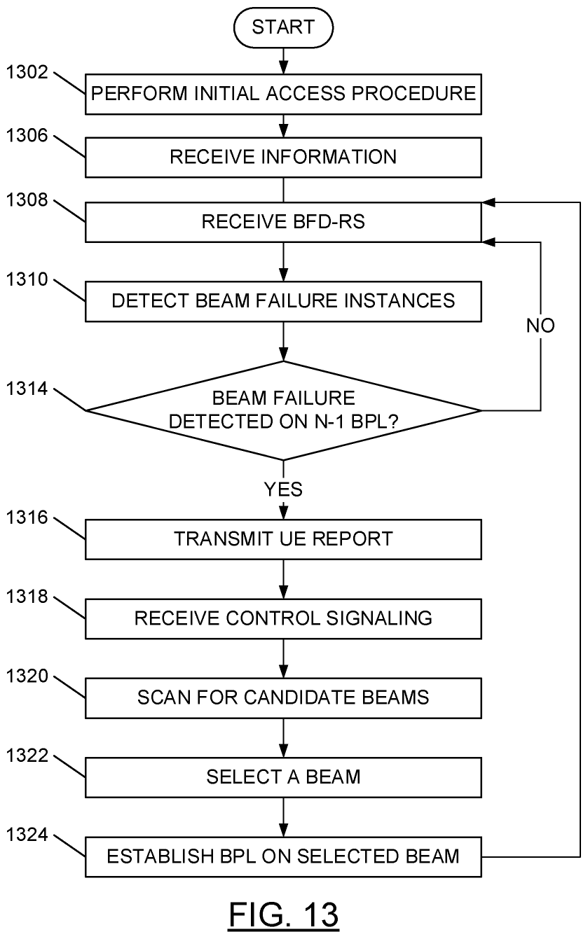

FIG. 12 illustrates, in a signal flow diagram, interaction between a UE 110, a T-TRP 170 and an NT-TRP 172. FIG. 13 illustrates example steps in a method of beam failure prevention.

To begin, the UE 110 engages the T-TRP 170 and performs (step 1302) an initial access procedure. The T-TRP 170 transmits information to the UE 110 using higher-layer signaling. The UE 110 receives (step 1306) the information. The information may, for example, include details of BFD-RSs to detect and, subsequently, measure in the context of N BPLs. The T-TRP 170 transmits BFD-RSs. The UE 110 receives (step 1308) the BFD-RSs from the T-TRP 170. On the basis of receiving (step 1308) and measuring the BFD-RSs from the T-TRP 170, the UE 110 may detect (step 1310) BFIs. Responsive to the detecting (step 1310), the UE 110 may determine (step 1314) whether beam failure has been detected for N−1 BPLs. A beam failure may be detected for a particular BPL on the basis of a predetermined number of BFIs having been detected on the particular BPL.

Responsive to the determining (step 1314) that beam failure has been detected for N−1 BPLs, the UE 110 transmits (step 1316), to the T-TRP 170, a UE report. The UE report may include an indication that beam failures have been detected for N−1 BPLs. The T-TRP 170, responsive to receiving the UE report, transmits, to the UE 110, an indication of directions of interest for scanning for candidate beams. The directions of interest for scanning for candidate beams may be defined in terms of directions of interest, using, e.g., Azimuth and Zenith angles defined in a given coordinate system, as determined by the T-TRP 170.

The UE 110 may, in response to receiving (step 1318) the control signaling, scan (step 1320) for candidate beams in those directions of interest and select (step 1322) a beam from the NT-TRP 172 or another, more suitable NT-TRP (not illustrated). The UE 110 may then establish (step 1324), on the selected beam, a fallback BPL, e.g., the BPL 904 with the NT-TRP 172.

Upon determining (step 1314) that beam failure has not been detected for N−1 BPLs, the UE 110 may return to receiving (step 1308) the BFD-RSs from the T-TRP 170.

In some embodiments where the UE needs to acquire UL synchronization on the new beam pair link, the step of the UE 110 establishing a new beam pair link may include the following steps:
the UE 110 scanning for candidate beams (or, equivalently, scanning for BFP-RS, CBD-RS, FB-RS), wherein the candidate beams' configuration, including, e.g., time and frequency resources and scrambling identifiers for sequence generation, was provided by the T-TRP 170 using higher-layer signaling;
the UE 110 selecting the best candidate beam out of the candidate beams whose configuration was provided by the T-TRP 170 using higher-layer signaling;
the UE 110 transmitting a Random Access preamble to the T-TRP 170 using the selected best candidate beam, wherein the Random Access preamble may be a contention-free Random Access preamble (e.g., associated with the selected candidate beam) or a contention-based Random Access preamble (e.g., selected randomly from a group of Random Access preambles); and
the UE 110 receiving a Random Access response from the T-TRP 170 over the selected best candidate beam before the Random Access Response window expired, thus concluding the Beam Failure Prevention procedure.

In some embodiments, the UE 110 acquires UL synchronization on the new beam pair link and the step of the UE 110 establishing a new beam pair link may include the following steps:
the UE 110 receiving an indication of the candidate beam (or equivalently: for BFP-RS, CBD-RS, FB-RS) to use to establish the new beam pair link, where the indication of the candidate beam is transmitted by the NW using lower-layer signaling, e.g., Medium Access Control Control Element (MAC-CE) or Downlink Control Information (DCI);
the indication of the candidate beam may include, e.g., the identifier of the corresponding reference signal, angular directions such as Azimuth and Zenith angles, and a Random Access preamble identifier, in order to assist the UE 110 in steering its transmit/receive beam and establish the new beam pair link;
the UE 110 transmitting a Random Access preamble to the T-TRP 170 using the indicated candidate beam, wherein the Random Access preamble may be a contention-free Random Access preamble (e.g., associated with the indicated candidate beam) or a contention-based Random Access preamble (e.g., selected randomly from a group of Random Access preambles); and
the UE 110 receiving a Random Access response from the T-TRP 170 over the selected best candidate beam before the Random Access Response window expired, thus concluding the Beam Failure Prevention procedure.

In some embodiments, the UE 110 doesn't acquire UL synchronization and the step of the UE 110 establishing a new beam pair link may include the following steps:
the UE 110 scanning for candidate beams (or, equivalently, for BFP-RS, CBD-RS, FB-RS), wherein the candidate beams' configuration, including, e.g., time and frequency resources and scrambling identifiers for sequence generation, was provided by the T-TRP 170 using higher-layer signaling;
the UE 110 selecting the best candidate beam out of the candidate beams whose information was provided by the T-TRP 170 using higher-layer signaling;
the UE 110 transmitting a candidate beam status report (or, equivalently, a BFP report, a CBD report, a FB report) over the functioning BPL, the report including the identifier of the selected best candidate beam; and
the UE 110 receiving a candidate beam status report acknowledgement from the T-TRP 170 over the functioning BPL, acknowledging receipt of the candidate beam status report and establishing the new beam pair link, thus concluding the Beam Failure Prevention procedure.

In some embodiments, the UE 110 doesn't acquire UL synchronization and the step of the UE 110 establishing a new beam pair link may include the UE 110 receiving an indication of the candidate beam (or, equivalently, for BFP-RS, CBD-RS, FB-RS) to use to establish the new beam pair link, where the indication of the candidate beam is transmitted by the T-TRP 170 using lower-layer signaling, e.g., MAC-CE or DCI. The indication of the candidate beam may include, e.g., the identifier of the corresponding reference signal and angular directions such as Azimuth and Zenith angles in order to assist the UE 110 in steering its transmit/receive beam and establish the new beam pair link.

In some embodiments, the UE 110 has different types of beam pair links, e.g., some of the beam pair links may be terrestrial Uu links (i.e., a link between a UE 110 and a fixed T-TRP 170), some of the beam pair links may be non-terrestrial Uu links (i.e., a link between a UE 110 and a NT-TRP 172), some of the beam pair links may be sidelinks (i.e., a link between a UE 110 and another UE 110).

In some embodiments, the T-TRP 170 transmits information to the UE 110 using higher-layer signaling. The UE 110 receives (step 1306) the information. The information includes details about candidate beams (or, equivalently, BFP-RS, CBD-RS or FB-RS) that correspond to beams being transmitted from other user devices, i.e., UEs 110. The T-TRP 170 transmits BFD-RSs. The UE 110 receives (step 1308) the BFD-RSs from the T-TRP 170. On the basis of receiving (step 1308) and measuring the BFD-RSs from the T-TRP 170, the UE 110 may detect (step 1310) BFIs. Responsive to the detecting (step 1310), the UE 110 may determine (step 1314) whether beam failure has been detected for N−1 BPLs. A beam failure may be detected for a particular BPL on the basis of a predetermined number of BFIs having been detected on the particular BPL. In response to the detection of beam failure on N−1 BPLs, the UE initiates Beam Failure Prevention procedure by scanning for candidate beams corresponding to sidelinks and establishing a sidelink as the fallback beam pair link based on the selected best sidelink candidate beam.

In some embodiments, the UE 110 signals its capability of performing beam failure prevention procedures to the T-TRP 170, e.g., after completing the Initial Access procedure (step 1102), using sidelink candidate beams. The capability of performing beam failure prevention using sidelink candidate beams may be mandatory or optional. As part of the capability of performing beam failure prevention, the UE 110 may also signal additional parameters such as the maximum number of sidelink candidate beams that the UE 110 can be configured to monitor for the purpose of running Beam Failure Prevention, which may further depend on the frequency range of the frequency band the UE 110 is operating in.

In some embodiments, the T-TRP 170 transmits information to the UE 110 using higher-layer signaling. The UE 110 receives (step 1306) the information. The information includes details about candidate beams (or equivalently BFP-RS, CBD-RS or FB-RS) that correspond to beams being transmitted from other user devices, i.e., UEs 110. The T-TRP 170 transmits BFD-RSs. The UE 110 receives (step 1308) the BFD-RSs from the T-TRP 170. On the basis of receiving (step 1308) and measuring the BFD-RSs from the T-TRP 170, the UE 110 may detect (step 1310) BFIs. Responsive to the detecting (step 1310), the UE 110 may determine (step 1314) whether beam failure has been detected for N−N_{functioning} BPLs. A beam failure may be detected for a particular BPL on the basis of a predetermined number of BFIs having been detected on the particular BPL. In response to the detection of beam failure on N−N_{functioning} BPLs, the UE initiates Beam Failure Prevention procedure by scanning for candidate beams and establishing a fallback beam pair link based on the selected best candidate beam. The number N_{functioning} denotes the number of functioning beam pair links, i.e., the number of beam pair links on which beam failure has not been detected, which number may be higher than 1. As part of operating the Beam Failure Prevention procedure, this number may be configured by the T-TRP 170 to the UE 110 using higher-layer signaling. As an example, if N_{functioning}=2 then the behavior of the UE 110 may include initiating the Beam Failure Prevention procedure as soon as N−N_{functioning} beam pair link failures have been detected or, equivalently, as soon as only N_{functioning} functioning beam pair links are left.

In some embodiments, the operation of monitoring for beam failure instances (i.e., the operation of computing the weighted sum of beam failure instances) may be referred as the UE 110 assessing a radio link quality, wherein the “radio link quality” refers to the weighted sum of beam failure instances. The UE 110 may assess the radio link quality against a threshold configured by the T-TRP 170. If the radio link quality exceeds the threshold, then the UE 110 is expected to initiate the Beam Failure Prevention procedure.

To explain a further aspect of the present application, it may be assumed, to begin, that a UE 110 is connected to a network using a terrestrial sub-system among a plurality of sub-systems, some sub-systems among the plurality of sub-systems are terrestrial and some sub-systems among the plurality of sub-systems are non-terrestrial. It is safe to assume that each sub-system is using different BPLs, where some of the BPLs are terrestrial BPLs and some of the BPLs are non-terrestrial BPLs. Terrestrial BPLs are illustrated in FIG. 9 as BPLs 902. A non-terrestrial BPL is illustrated in FIG. 9 as BPL 904.

Aspects of the present application relate to categorizing beam failures as either “minor” or “major.”

A threshold, Nₘᵢₙₒᵣ, may be predefined to allow the UE 110 to detect a beam failure and then categorize the beam failure as a minor beam failure. In operation, the UE 110 may monitor for receipt of BFD-RSs on particular BPLs in particular measurement intervals. Consequently, the UE 110 may detect BFIs in a consecutive number of measurement intervals. Upon determining that the consecutive number of measurement intervals in which BFIs have been detected exceeds the predefined threshold, Nₘᵢₙₒᵣ, the UE 110 may detect a beam failure and then categorize the beam failure as a minor beam failure.

Upon detecting the beam failure categorized as minor, the UE 110 may initiate a minor beam failure recovery procedure, wherein the UE 110 scans for candidate beams that belong to the same sub-system as the sub-system wherein the beam failure categorized as minor was detected. In parallel to the minor beam failure recovery procedure, the UE 110 may also be configured to continue to monitor for receipt of BFD-RSs on particular BPLs in particular measurement intervals.

The UE 110 may be configured with a minor beam failure recovery window defined as N_{minor_recovery} measurement intervals. Over the duration of the minor beam failure recovery window, the UE 110 attempts to find a suitable beam to, thereby, complete the minor beam failure recovery procedure.

A threshold, Nₘₐⱼₒᵣ, may be predefined to allow the UE 110 to detect a beam failure and then categorize the beam failure as a major beam failure.

Over the duration of the minor beam failure recovery window, the UE 110 may monitor for receipt of BFD-RSs on particular BPLs in particular measurement intervals. Consequently, the UE 110 may detect BFIs in a consecutive number of measurement intervals. Upon determining that the consecutive number of measurement intervals in which BFIs have been detected, during the minor beam failure recovery window, exceeds the predefined threshold, Nₘₐⱼₒᵣ, the UE 110 may detect a beam failure and then categorize the beam failure as a major beam failure.

Upon detecting a beam failure categorized as major, the UE 110 may be triggered to implement a major beam failure recovery procedure wherein the UE 110 scans for candidate beams that belong to a sub-system that is different from the sub-system wherein the beam failure categorized as major was detected. The UE 110 attempts to find a suitable beam to, thereby, complete the major beam failure recovery procedure.

In keeping with the weighting of received BFIs, BFIs that are detected before the quantity of detected BFIs exceeds the predefined threshold, Nₘᵢₙₒᵣ, may be assigned, by the UE 110, a first weight and BFIs that are detected after the quantity of detected BFIs exceeds the predefined threshold, Nₘᵢₙₒᵣ, may be assigned, by the UE 110, a second weight.

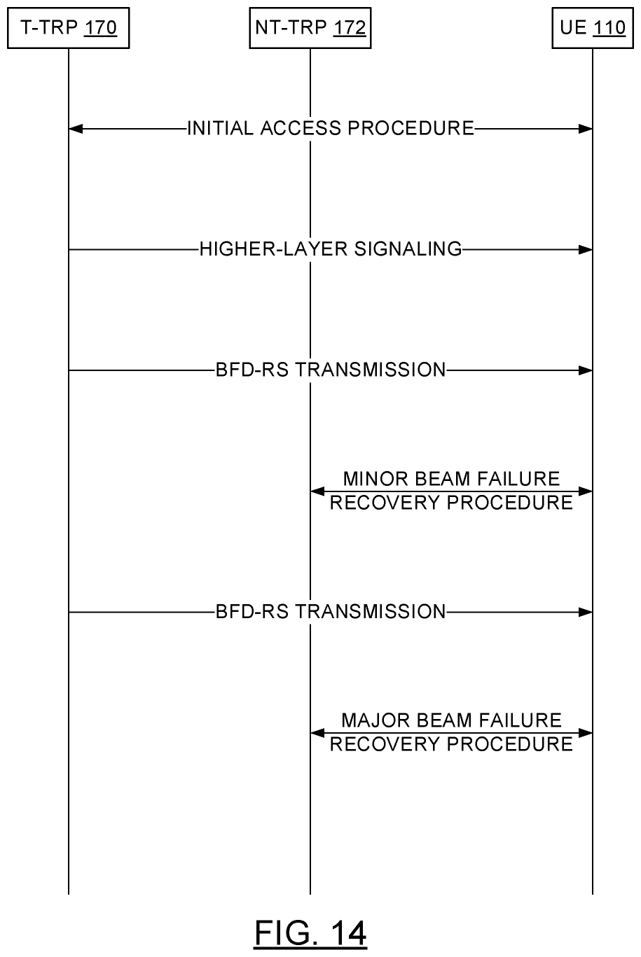

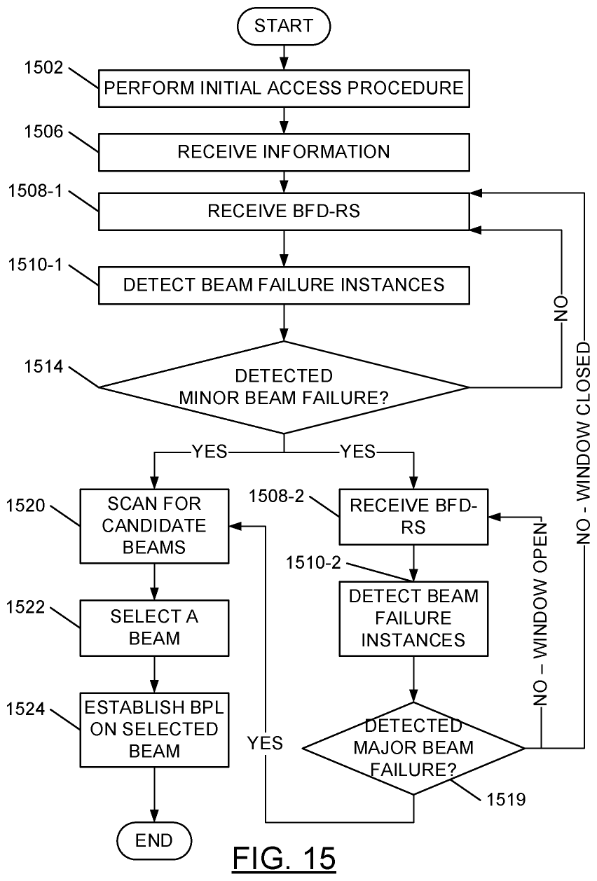

FIG. 14 illustrates, in a signal flow diagram, interaction between a UE 110, a T-TRP 170 and an NT-TRP 172. FIG. 15 illustrates example steps in a method of beam failure recovery with categorization.

To begin, the UE 110 engages the T-TRP 170 and performs (step 1502) an initial access procedure. The T-TRP 170 transmits information to the UE 110 using higher-layer signaling. The UE 110 receives (step 1506) the information. The information may, for example, include details of BFD-RSs to detect and, subsequently, measure in the context of N BPLs. The T-TRP 170 transmits BFD-RSs. The UE 110 receives (step 1508-1) the BFD-RSs from the T-TRP 170. On the basis of receiving (step 1508-1) and measuring the BFD-RSs from the T-TRP 170, the UE 110 may detect (step 1510-1) BFIs. Responsive to the detecting (step 1510-1), the UE 110 may determine (step 1514) whether Nₘᵢₙₒᵣ BFIs have been detected. Upon determining (step 1514) that Nₘᵢₙₒᵣ BFIs have been detected, the UE 110 may detect a beam failure categorized as minor.

Upon detecting a beam failure categorized as minor, the UE 110 may proceed to initiate the minor beam failure recovery procedure, which, as discussed hereinbefore, involves parallel activities. In one of the parallel activities, the UE 110 scans (step 1520) for candidate beams from the T-TRP 170 and selects (step 1522) a beam from the T-TRP 170. The UE 110 establishes (step 1524) a BPL with the T-TRP 170 on the selected beam. In the other of the parallel activities, the UE 110 continues to receive (step 1508-2), in whole or in part, the BFD-RSs from the T-TRP 170. On the basis of receiving (step 1508-2) and measuring the BFD-RSs from the T-TRP 170, the UE 110 may detect (step 1510-2) BFIs. Responsive to the detecting (step 1510-2), the UE 110 may determine (step 1519) whether Nₘₐⱼₒᵣ BFIs have been detected. Upon determining (step 1519) that Nₘₐⱼₒᵣ BFIs have been detected, the UE 110 may detect a beam failure categorized as major.

Upon determining (step 1519) that Nₘₐⱼₒᵣ BFIs have not been detected while the minor beam failure recovery window is open, the UE 110 may continue to receive (step 1508-2) the BFD-RSs from the T-TRP 170.

Upon determining (step 1519) that Nₘₐⱼₒᵣ BFIs have not been detected and that the minor beam failure recovery window has closed, the UE 110 may return to receiving (step 1508-1) the BFD-RSs from the T-TRP 170 outside of the minor beam failure recovery procedure.

Upon detecting a beam failure categorized as major, the UE 110 may proceed to scan (step 1520) for candidate beams from the NT-TRPs 172 and select (step 1522) a beam from the NT-TRP 172 or another, more suitable NT-TRP (not illustrated). The UE 110 establishes (step 1524) a BPL with the NT-TRP 172 on the selected beam.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving beam failure detection reference signals on a plurality of beam pair links;
detecting beam failure on at least some of the plurality of beam pair links; and
responsive to a quantity of beam pair links on which the beam failure has been detected exceeding a predetermined quantity of beam pair links and being less than a total quantity of the plurality of beam pair links, establishing a new beam pair link on a candidate beam.

2. The method of claim 1, wherein the detecting the beam failure comprises:
detecting, based on measuring the beam failure detection reference signals for a given beam pair link among the plurality of beam pair links, a plurality of consecutive beam failure instances.

3. The method of claim 1, further comprising:
selecting the candidate beam among a plurality of candidate beams.

4. The method of claim 1, wherein the plurality of beam pair links are terrestrial beam pair links, and the new beam pair link is a non-terrestrial beam pair link.

5. The method of claim 1, further comprising:
transmitting a report indicating the beam failure on the quantity of beam pair links on which the beam failure has been detected.

6. The method of claim 3, further comprising:
receiving control signaling indicating directions for the plurality of candidate beams.

7. A device comprising:
at least one processor; and
a non-transitory computer readable storage medium storing programming, the programming including instructions that, when executed by the at least one processor, cause the device to perform operations including:
receiving beam failure detection reference signals on a plurality of beam pair links; and
detecting beam failure on at least some of the plurality of beam pair links; and
responsive to a quantity of beam pair links on which the beam failure has been detected exceeding a predetermined quantity of beam pair links and being less than a total quantity of the plurality of beam pair links, establishing a new beam pair link on a candidate beam.

8. The device of claim 7, wherein the detecting the beam failure comprises:
detecting, based on measuring the beam failure detection reference signals for a given beam pair link among the plurality of beam pair links, a plurality of consecutive beam failure instances.

9. The device of claim 7, the operations further comprising:
selecting the candidate beam among a plurality of candidate beams.

10. The device of claim 7, wherein the plurality of beam pair links are terrestrial beam pair links, and the new beam pair link is a non-terrestrial beam pair link.

11. The device of claim 7, the operations further comprising:
transmitting a report indicating the beam failure on the quantity of beam pair links on which the beam failure has been detected.

12. The device of claim 9, the operations further comprising:
receiving control signaling indicating directions for the plurality of candidate beams.

13. A non-transitory computer readable storage medium storing instructions, when executed by an apparatus, cause the apparatus to perform operations including:
receiving beam failure detection reference signals on a plurality of beam pair links; and
detecting beam failure on at least some of the plurality of beam pair links; and
responsive to a quantity of beam pair links on which the beam failure has been detected exceeding a predetermined quantity of beam pair links and being less than a total quantity of the plurality of beam pair links, establishing a new beam pair link on a candidate beam.

14. The non-transitory computer readable storage medium of claim 13, wherein the detecting the beam failure comprises:
detecting, based on measuring the beam failure detection reference signals for a given beam pair link among the plurality of beam pair links, a plurality of consecutive beam failure instances.

15. The non-transitory computer readable storage medium of claim 13, the operations further comprising:
selecting the candidate beam among a plurality of candidate beams.

16. The non-transitory computer readable storage medium of claim 13, wherein the plurality of beam pair links are terrestrial beam pair links, and the new beam pair link is a non-terrestrial beam pair link.

17. The non-transitory computer readable storage medium of claim 13, the operations further comprising:
transmitting a report indicating the beam failure on the quantity of beam pair links on which the beam failure has been detected.

18. The non-transitory computer readable storage medium of claim 15, the operations further comprising:
receiving control signaling indicating directions for the plurality of candidate beams.
